(19) United States
(12) Patent Application Publication
(10) Pub. No.: US 2026/0196014 A1
(43) Pub. Date: Jul. 9, 2026

(54) METHODS, SYSTEMS, ARTICLES OF MANUFACTURE AND APPARATUS TO PERFORM VIDEO ANALYTICS

(71) Applicant: Intel Corporation, Santa Clara, CA (US)

(72) Inventors: Jie Xia, Shanghai (CN); Xin Feng Dong, Shanghai (CN); Guangxian Li, Shanghai (CN); Changliang Wang, Bellevue, WA (US)

(73) Assignee: Intel Corporation, Santa Clara, CA (US)

(21) Appl. No.: 18/865,604

(22) PCT Filed: Jun. 16, 2022
(86) PCT No.: PCT/CN2022/099198

§ 371 Date: Nov. 13, 2024

(51) Int. Cl. G06V 10/50; G06V 10/26

(52) U.S. Cl. CPC G06V 10/50; G06V 10/26

(57) ABSTRACT

Methods, apparatus, systems, and articles of manufacture are disclosed. An example apparatus includes: at least one memory; machine readable instructions; and processor circuitry to execute the machine readable instructions to: generate macroblocks from an image frame, the macroblocks to meet at a convergence point; assign compute units to the macroblocks to process pixels of the macroblocks in parallel; perform a convergent sweep of the macroblocks with the compute units, the convergent sweep to process pixels of the macroblocks starting at corners opposite the convergence point and ending at the convergence point; and perform a divergent sweep of the macroblocks with the compute units, the divergent sweep to process the pixels of the macroblocks starting from the convergence point and ending at the corners opposite the convergence point.

### FIELD OF THE DISCLOSURE

This disclosure relates generally to image and video analytics and, more particularly, to methods, systems, articles of manufacture and apparatus to process image frames.

### BACKGROUND

Computer vision is a subfield of artificial intelligence that seeks to extract and interpret information from digital images and/or videos. Computer vision often uses machine learning techniques to extract useful information from the digital images and/or videos.

### BRIEF DESCRIPTION OF THE DRAWINGS

FIG. 1 is a block diagram of example image processing circuitry.

FIG. 2 is an illustration of an example convergent sweep executed by the example image processing circuitry of FIG. 1.

FIG. 3 is an illustration of an example divergent sweep executed by the example image processing circuitry of FIG. 1.

FIG. 4 is another example of a convergent sweep performed on a macroblock by the example image processing circuitry of FIG. 1.

FIG. 5 includes example tables that illustrate performance improvements to computer hardware provided by the example image processing circuitry of FIG. 1.

FIG. 6 includes another example table that illustrates example error rates associated with the example image processing circuitry of FIG. 1.

FIG. 7 is a flowchart representative of example machine readable instructions and/or example operations that may be executed by example processor circuitry to implement the image processing circuitry of FIG. 1.

FIG. 8 is a flowchart representative of example machine readable instructions and/or example operations that may be executed by example processor circuitry to implement a divergent sweep.

FIG. 9 is a flowchart representative of example machine readable instructions and/or example operations that may be executed by example processor circuitry to implement a convergent sweep.

FIG. 10 is a block diagram of an example processing platform including processor circuitry structured to execute the example machine readable instructions and/or the example operations of FIGS. 7-9 to implement the image processing circuitry of FIG. 1.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine readable instructions of FIGS. 7-9 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” and/or “substantially simultaneously” refers to occurrence in a near instantaneous manner recognizing there may be real world delays for computing time, transmission, propagation latency, etc. Thus, unless otherwise specified, “substantially real time” and/or “substantially simultaneously” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

In computer vision, a model may be trained with data to recognize patterns and/or associations. The model may then follow such patterns and/or associations when processing new input, producing output consistent with the recognized patterns and/or associations. Optical flow and image segmentation are computationally intensive computer vision tasks that carry out distance transforms to extract information from images.

A distance transform (e.g., a geodesic distance transform) is computer vision task that is used in a variety of computer vision workloads (e.g., autonomous driving, motion prediction, etc.). A distance transform accepts a greyscale cost image together with a set of seed points. The distance transform then outputs a value for each pixel representing the geodesic distance from each pixel to its nearest seed point. Distance transforms are used in a variety of artificial intelligence (AI) applications. For example, distance transforms appear in AI applications such as motion planning for autonomous vehicles, robotics, and medical analytics.

Raster scan is a conventional method used for distance map computations. Conventional methods of performing distance transform are computationally complex as distance transforms have traditionally been performed sequentially and often include pixel-level dependencies. Such pixel-level dependencies are difficult to parallelize as information about relationships between pixels can be lost during parallelization. Many conventional GPU-based distance transform implementations process small regions (e.g., small rectangular regions). In such conventional implementations, each GPU thread sweeps a small rectangular region, with performance improvements primarily arising from increases in GPU thread count.

Many conventional GPU implementations focus on parallelism of a single sweep (e.g., a single pass) with all GPU threads running simultaneously and each thread processing conventionally sized macroblocks (e.g., 20 macroblocks per frame). However, many such implementations are limited and only determine shortest paths to seeds within the conventionally sized macroblock. Failure to use information outside of the conventionally sized macroblock often produces a local optimum rather than a global optimum.

Conventional methods that perform only a single iteration can produce insufficient results with large discrepancies between the local optimum and ground truth values. Therefore, conventional solutions often require many iterations to achieve a global optimum with sufficient accuracy. Repetitive iterations increase computational load and causes unacceptable latency (e.g., execution time to generate a distance map). Thus, many time sensitive operations (e.g., autonomous driving, robotic control, etc.) cannot rely on conventional distance transform methods.

In examples described herein, a wave of pixels is a diagonal grouping of pixels that is processed together. For example, a rectangular macroblock with an overlayed coordinate plane may have a bottom left corner indexed (0,0) and an upper right corner indexed (r, c), wherein r is a number of rows and c is a number of columns of the macroblock. A zeroth wave would include all pixels that fall on a line connecting points (0,1) and (1,0) of the coordinate plane. A first wave of pixels would include all pixels that fall on a line connecting points (2,0) and (0, 2) of the coordinate plane. In other words, waves of pixels can be understood to form an isosceles right triangle with a corner of a macroblock.

From another perspective, if pixels themselves are numbered, with a bottom left pixel of the macroblock labeled (0, 0) and a top-right pixel labeled (r, c), pixels within a wave share certain geometric characteristics. For example, pixels within a wave have coordinates that share a characteristic value c−r+n, wherein c is the column, r is the row, and n is the width of the macroblock.

In some examples, waves are developed iteratively. Each successive wave of pixels includes pixels that neighbor a previously processed wave and share a row or column with the previously processed wave. For example, a zeroth wave includes the pixel (0, 0). A successive wave of pixels can be formed by taking each pixel of the first wave and adding 1 to either the row or column value (e.g., while ignoring duplicates). Thus, a first wave would include values (1, 0) and (0, 1).

In some examples, waves are processed iteratively. As waves of pixels are processed, an in-process wave is called a wavefront (e.g., a frontier wave). The above descriptions of waves, seeds, and wavefronts are meant to illustrate general present in certain examples. Further descriptions and variations of waves, wavefronts, and seeds will be provided in association with the following figures.

In contrast to conventional solutions, examples disclosed herein execute a distance transform (e.g., generate a distance map) with only two sweep phases: a convergent phase and a divergent phase. The convergent phase includes a first sweep that starts at four corner pixels and propagates towards a convergence (e.g., center pixel, origin pixel) point. In some examples, the first sweep determines a shortest path to first seeds at vertical and horizontal symmetry axes. Then, a divergent phase sweeps from a convergence pixel (e.g., a center pixel, an origin pixel) towards four corner pixels to determine a shortest path to second seeds farther from the vertical and horizontal symmetry axes than the first seeds.

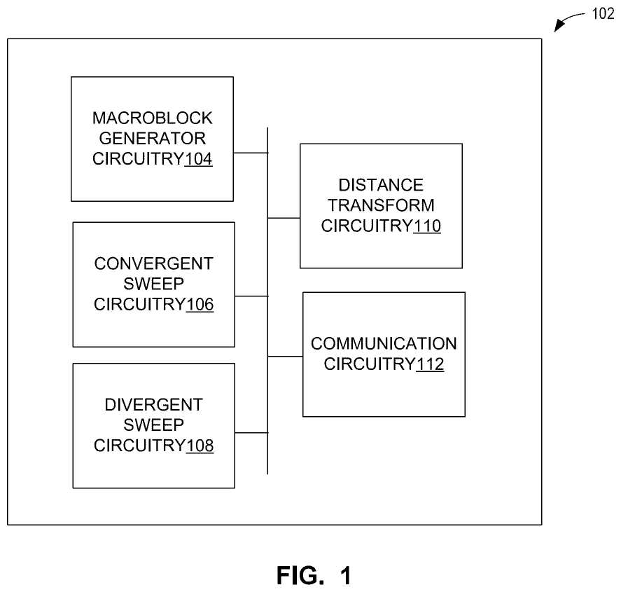

Turning to the figures, FIG. 1 is a block diagram of example image processing circuitry 102. The example image processing circuitry 102 includes example macroblock generator circuitry 104, example convergent sweep circuitry 106, example divergent sweep circuitry 108, example distance transform circuitry 110, and example communication circuitry 112.

FIG. 1 is a block diagram of the example image processing circuitry 102 to perform image analytics. The image processing circuitry 102 of FIG. 1 may be instantiated (e.g., creating an instance of, bring into being for any length of time, materialize, implement, etc.) by processor circuitry such as a central processing unit executing instructions. Additionally or alternatively, the image processing circuitry 102 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by one or more virtual machines and/or containers executing on the microprocessor.

The example macroblock generator circuitry 104 splits a frame (e.g., an image frame, a video frame) into a plurality of non-overlapping regions (e.g., macroblocks). Specifically, the example macroblock generator circuitry 104 splits a frame into four macroblocks, with each of the four macroblocks having the same number of pixels. The example macroblock generator circuitry 104 may determine a convergence point (e.g., origin point, center point) of the frame by determining midpoints of outer edges of an image frame and using the midpoints to find one or more center pixels. The example macroblock generator circuitry 104 may then generate vertical and horizontal symmetry axes that are used to categorize pixels into respective macroblocks.

Although the example macroblock generator circuitry 104 generates four macroblocks with equivalent numbers of pixels, examples disclosed herein are not limited to generation of four macroblocks. For example, the macroblock generator circuitry 104 may split a frame into any number of macroblocks (e.g., 2 macroblocks, 6 macroblocks, 50 macroblocks, etc.). Furthermore, in some examples, the macroblock generator circuitry 104 does not generate symmetrical macroblocks. Example corner-to-origin wavefront-based processing techniques described herein may be utilized on asymmetrical macroblocks, non-rectangular macroblocks, etc.

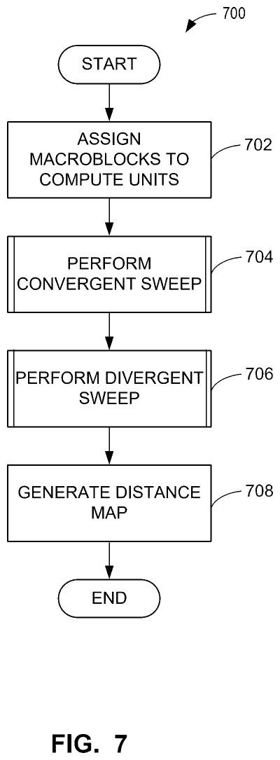

In some examples, the macroblock generator circuitry 104 is instantiated by processor circuitry executing macroblock generator instructions and/or configured to perform operations such as those represented by the flowchart of FIGS. 7-9.

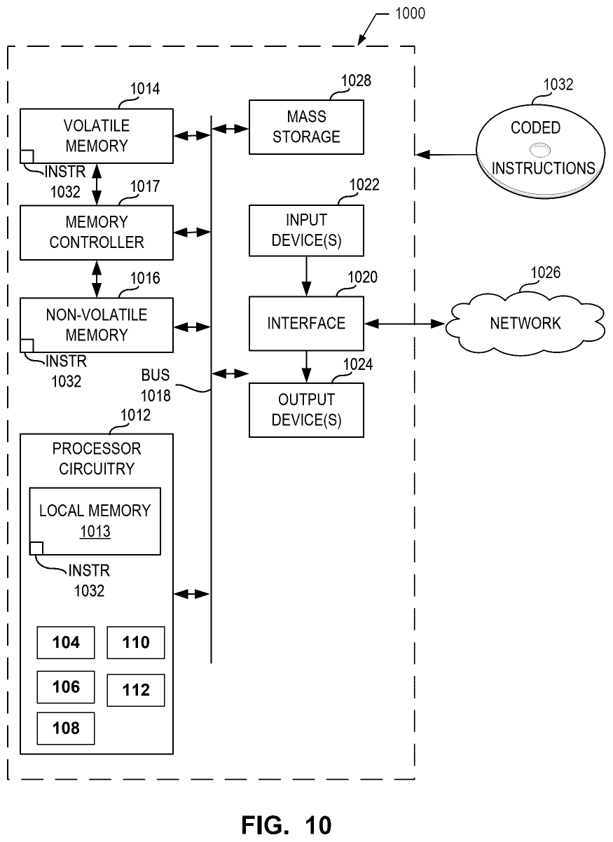

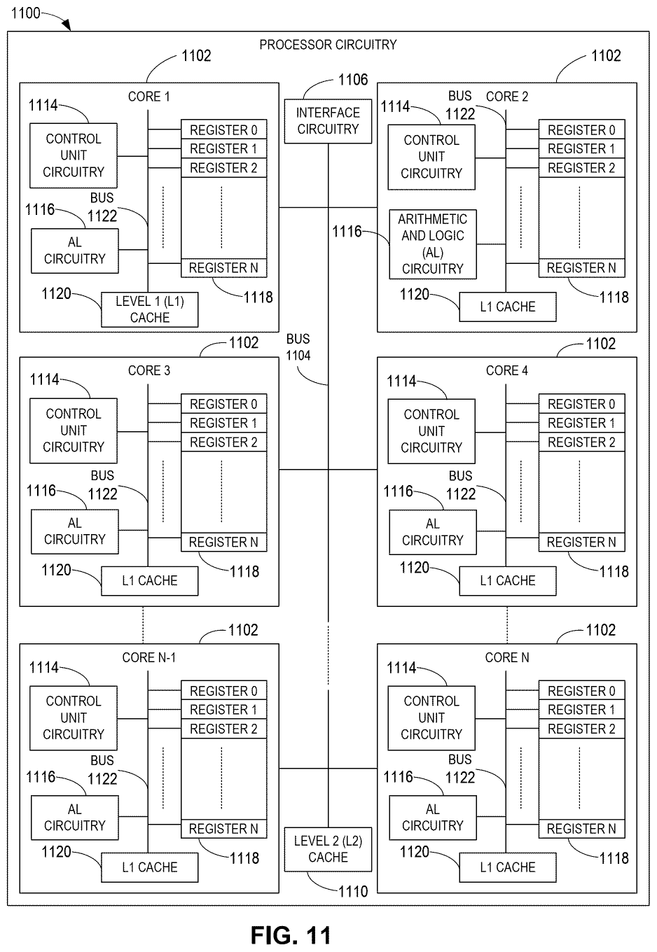

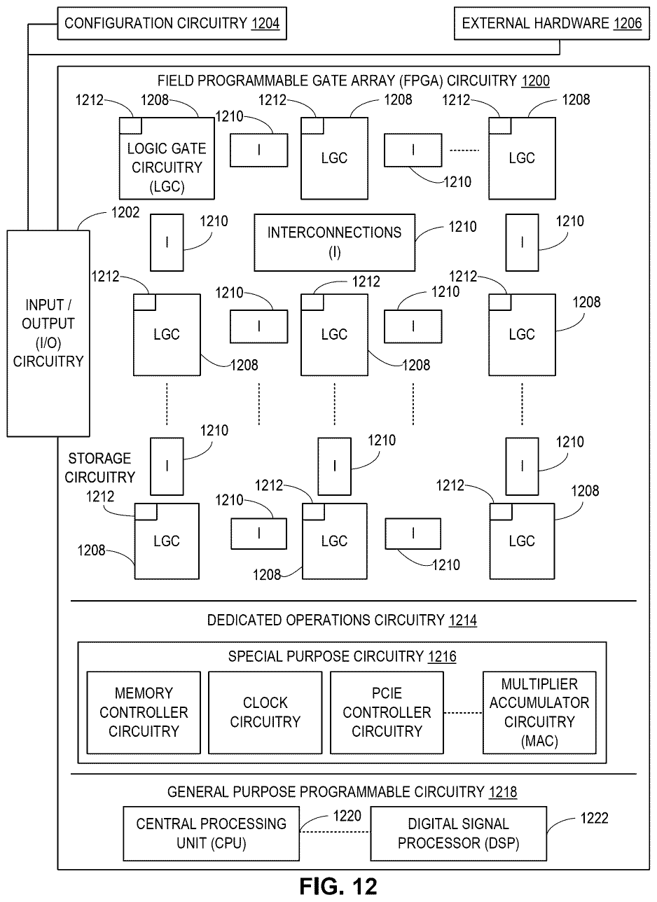

In some examples, the image processing circuitry 102 includes means for splitting an image into a plurality of macroblocks and/or generating a plurality of macroblocks from an image frame, the plurality of macroblocks to meet at a convergence point. For example, the means for generating may be implemented by example macroblock generator circuitry 104. In some examples, the example macroblock generator circuitry 104 may be instantiated by processor circuitry such as the example processor circuitry 1012 of FIG. 10. For instance, the example macroblock generator circuitry 104 may be instantiated by the example microprocessor 1100 of FIG. 11 executing machine executable instructions such as those implemented by at least blocks 702, of FIG. 7. In some examples, the example macroblock generator circuitry 104 may be instantiated by hardware logic circuitry, which may be implemented by an ASIC, XPU, or the FPGA circuitry 1200 of FIG. 12 structured to perform operations corresponding to the machine readable instructions. Additionally or alternatively, the example macroblock generator circuitry 104 may be instantiated by any other combination of hardware, software, and/or firmware. For example, the example macroblock generator circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

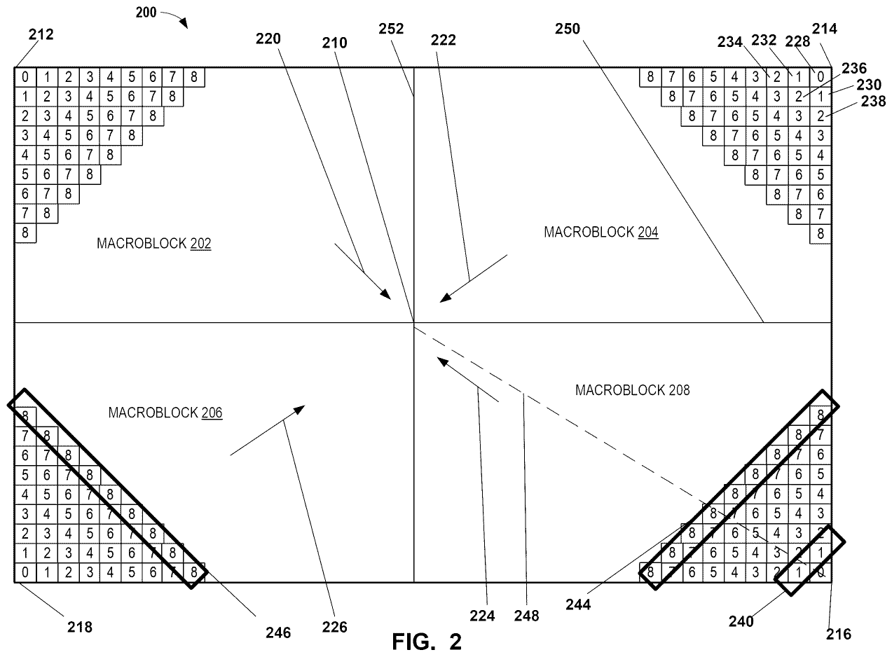

The example convergent sweep circuitry 106 performs distance transform calculations on waves of pixels (e.g., groups of pixels, sets of pixels) extending from a directional sweep line. As described herein, a directional sweep line is a straight line that extends between the convergence point (e.g., origin point, midpoint, center point) and a point on the exterior of the macroblock (e.g. an opposite corner, an opposite side, a corner opposite the convergence point). For example, in square shaped macroblocks, disclosed herein, the directional sweep line bisects an angle formed by horizontal and vertical symmetry axes. Accordingly, in rectangular shaped macroblocks, the directional sweep line would not bisect the angle formed by the horizontal and vertical symmetry axes. An example of a directional sweep line is illustrated and described in association with FIG. 2 and described in further detail below.

The example convergent sweep circuitry 106 processes waves of macroblocks along the directional sweep line. The example convergent sweep circuitry 106 starts at a first end of the directional sweep line, the first end opposite to the convergence point. After a first wave of pixels is processed, the example convergent sweep circuitry 106 processes a second wave of pixels adjacent to the first wave and closer to the convergence point. In other words, a second wave of pixels includes pixels that are row-wise or column-wise adjacent to pixels of the first wave and closer to the origin (e.g., one unit closer to convergence point along horizontal or vertical symmetry axes).

The example convergent sweep circuitry 106 sweeps (e.g., processes) four macroblocks (e.g., an upper left quadrant macroblock, an upper right quadrant macroblock, a lower left quadrant macroblock, and a lower right quadrant macroblock) substantially simultaneously in waves of pixels, the waves of pixels processed towards the frame center (e.g., the convergence point). For example, in a square-shaped macroblock, each wave of pixels is disposed along lines orthogonal to the directional guide line. In rectangular macroblocks, each wave of pixels is at a non-orthogonal angle to the directional guide line, and parallel to the other waves of pixels within the macroblock. The convergent sweep circuitry 106 ends the convergent sweep when wavefronts (e.g., the wave of pixels closest to the convergence point that have not been processed) from each macroblock converge at the convergence point.

In some examples, the convergent sweep circuitry 106 is instantiated by processor circuitry executing macroblock generator instructions and/or configured to perform operations such as those represented by the flowchart of FIGS. 7-9.

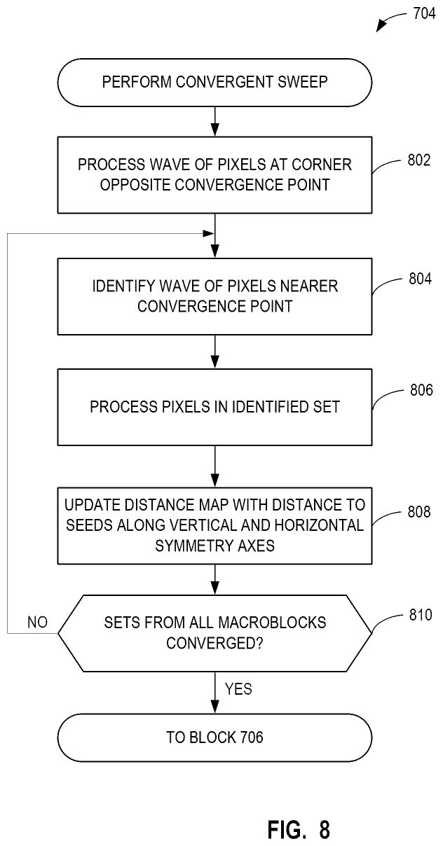

In some examples, the convergent sweep circuitry 106 includes means for performing a convergent sweep of a plurality of macroblocks with a plurality of compute units, the convergent sweep to process pixels of the plurality of macroblocks starting at corners opposite a convergence point, the convergent sweep complete when all pixels of the plurality of macroblocks are processed by the convergent sweep. For example, the means for processing may be implemented by convergent sweep circuitry 106. In some examples, the example convergent sweep circuitry 106 may be instantiated by processor circuitry such as the example processor circuitry 1012 of FIG. 10. For instance, the example convergent sweep circuitry 106 may be instantiated by the example microprocessor 1100 of FIG. 11 executing machine executable instructions such as those implemented by at least blocks 802-810 FIG. 8 In some examples, the convergent sweep circuitry 106 may be instantiated by hardware logic circuitry, which may be implemented by an ASIC, XPU, or the FPGA circuitry 1200 of FIG. 12 structured to perform operations corresponding to the machine readable instructions. Additionally or alternatively, the convergent sweep circuitry 106 may be instantiated by any other combination of hardware, software, and/or firmware. For example, the convergent sweep circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example image processing circuitry 102 includes the example divergent sweep circuitry 108. The example divergent sweep circuitry 108 performs distance transform calculations on groups of pixels (e.g., waves of pixels, sets of pixels) extending from the directional sweep line.

The example divergent sweep circuitry 108 starts a divergent sweep at the convergence point. The example divergent sweep circuitry 108 then processes a first wave of pixels. After the first wave of pixels is processed, the example divergent sweep circuitry 108 processes a second wave of pixels (e.g., a second set of pixels along the directional guide line) adjacent to the first wave and closer to an end of the frame opposite the convergent point (e.g., farthest from the convergent point).

The example divergent sweep circuitry 108 sweeps four macroblocks (e.g., an upper left quadrant macroblock, an upper right quadrant macroblock, a lower left quadrant macroblock, and a lower right quadrant macroblock) substantially simultaneously in waves of pixels, the waves of pixels processed from the frame center to the perimeter of the frame, the waves of pixels forming a series of parallel lines crossing the directional guide line. The divergent sweep circuitry 108 ends the divergent sweep when wavefronts (e.g., the wave of pixels farthest from the convergence point that have not been processed) from each macroblock reach respective corners of the frame.

In some examples, the divergent sweep circuitry 108 is instantiated by processor circuitry executing macroblock generator instructions and/or configured to perform operations such as those represented by the flowchart of FIGS. 7-9.

In some examples, the divergent sweep circuitry 108 includes second means for performing a divergent sweep of a plurality of macroblocks with a plurality of compute units, the divergent sweep to process pixels of the plurality of macroblocks starting from a convergence point and ending at corners opposite the convergence point, the divergent sweep complete when pixels of the plurality of macroblocks are processed by the divergent sweep.

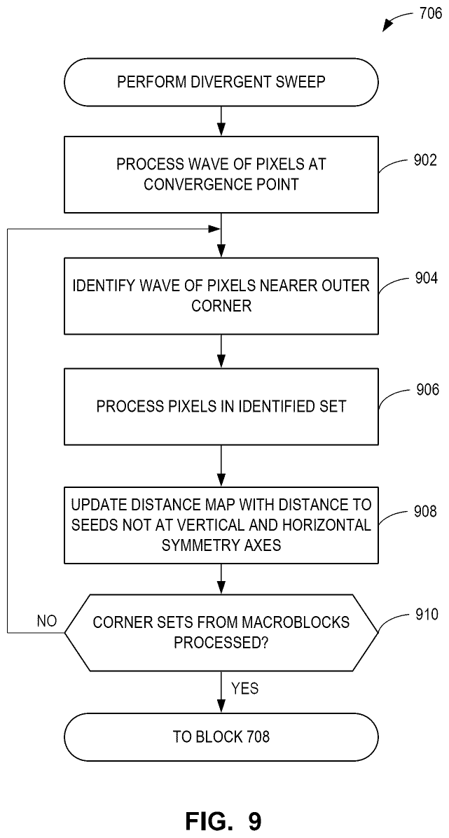

For example, the second means for performing may be implemented by the divergent sweep circuitry 108. In some examples, the example divergent sweep circuitry 108 may be instantiated by processor circuitry such as the example processor circuitry 1012 of FIG. 10. For instance, the example divergent sweep circuitry 108 may be instantiated by the example microprocessor 1100 of FIG. 11 executing machine executable instructions such as those implemented by at least blocks 902-910 FIG. 9. In some examples, the divergent sweep circuitry 108 may be instantiated by hardware logic circuitry, which may be implemented by an ASIC, XPU, or the FPGA circuitry 1200 of FIG. 12 structured to perform operations corresponding to the machine readable instructions. Additionally or alternatively, the divergent sweep circuitry 108 may be instantiated by any other combination of hardware, software, and/or firmware. For example, the divergent sweep circuitry 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example image processing circuitry 102 includes the example distance transform circuitry 110. The example distance transform circuitry 110 generates a distance map as the example convergent sweep circuitry 106 and the example divergent sweep circuitry 108 operate. The example distance transform circuitry 110 performs calculations on pixels, determining shortest paths from seed values (e.g., points of interest) to pixels of the macroblock.

The example distance transform circuitry 110 generates a distance map based on both the convergent sweep and the divergent sweep. During the convergent sweep, the distance transform circuitry 110 generates shortest paths from pixels of the plurality of pixels of a macroblock to first seeds (e.g., nearer vertical and horizontal symmetry axes). During the divergent sweep, the example distance transform circuitry 110 generates shortest paths from the pixels of the plurality to second seeds, the second seeds farther from vertical and horizontal symmetry axes of the image frame than the first seeds. The example distance transform circuitry 110 can produce a distance map that incorporates information from shortest paths to both of the first seeds and the second seeds.

In some examples, the image processing circuitry 102 does not include the example distance transform circuitry 110 and instead the operations of the example distance transform circuitry 110 are performed by the convergent sweep circuitry 106 and/or the divergent sweep circuitry 108.

In some examples, the example convergent sweep circuitry 106 and the example divergent sweep circuitry 108 may not perform a distance transform, and instead can perform other operations on macroblocks of an image. For example, the operations performed by the example convergent sweep circuitry 106 and the example divergent sweep circuitry 108 may include operations to conduct a search/traverse algorithm or implement any type of pixel level operations. In some examples, the distance transform circuitry 110 is instantiated by processor circuitry executing macroblock generator instructions and/or configured to perform operations such as those represented by the flowcharts of FIGS. 7-9.

In some examples, the distance transform circuitry 110 includes means for generating a distance map based on a convergent sweep and based on a divergent sweep, the convergent sweep to generate shortest paths from pixels of the plurality of pixels to first seeds, the divergent sweep to generate shortest paths from the pixels of the plurality to second seeds, the second seeds farther away from vertical and horizontal symmetry axes of the image frame than the first seeds. For example, the means for generating may be implemented by distance transform circuitry 110. In some examples, the example distance transform circuitry 110 may be instantiated by processor circuitry such as the example processor circuitry 1012 of FIG. 10. For instance, the example distance transform circuitry 110 may be instantiated by the example microprocessor 1100 of FIG. 11 executing machine executable instructions such as those implemented by at least blocks 708 of FIG. 7, 806-808 of FIG. 8, and 906-908 of FIG. 9. In some examples, the distance transform circuitry 110 may be instantiated by hardware logic circuitry, which may be implemented by an ASIC, XPU, or the FPGA circuitry 1200 of FIG. 12 structured to perform operations corresponding to the machine readable instructions. Additionally or alternatively, the distance transform circuitry 110 may be instantiated by any other combination of hardware, software, and/or firmware. For example, the distance transform circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example image processing circuitry 102 additionally includes the example communication circuitry 112. The example communication circuitry 112 facilitates communication between the macroblock generator circuitry 104, the example convergent sweep circuitry 106, the example distance transform circuitry 110, and the example communication circuitry 112. The example communication circuitry 112 additionally can transmit and/or receive data from any helper compute units (e.g., a GPU, a hardware accelerator, additional CPUs, etc.) that may help perform the distance transform.

While an example manner of implementing the image processing circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example macroblock generator circuitry 104, the example convergent sweep circuitry 106, the example divergent sweep circuitry 108, the example distance transform circuitry 110, and the example communication circuitry 112, and/or more generally the example image processing circuitry 102 of FIG. 1 may be implemented by hardware alone or by hardware in combination with software and/or firmware. Thus, for example, any of the example macroblock generator circuitry 104, the example convergent sweep circuitry 106, the example divergent sweep circuitry 108, the example distance transform circuitry 110, and the example communication circuitry 112, and/or more generally the example image processing circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example image processing circuitry 102 of FIG. 1 may include one or more elements, processes, and/or devices in addition to, or instead of, those illustrated in FIG. 1, and/or may include more than one of any or all of the illustrated elements, processes and devices.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is an illustration of an image frame 200. The example image frame 200 includes an example convergence point 210, an example first corner 212 (e.g., an upper left corner), an example second corner 214 (e.g., an upper right corner), an example third corner 216 (e.g., a lower right corner), an example fourth corner 218 (e.g., a lower left corner), an example first directional arrow 220, an example second directional arrow 222, an example third directional arrow 224, an example fourth directional arrow 226, an example first pixel 228, an example second pixel 230, an example third pixel 232, an example fourth pixel 234, an example fifth pixel 236, an example sixth pixel 238, an example first convergent wave 240, an example eighth convergent wave 244, an example third convergent wave 246, an example directional guide line 248, an example horizontal symmetry axis 250, and an example vertical symmetry axis 252.

The example image frame 200 includes the example horizontal symmetry axis 250 and the example vertical symmetry axis 252. The example horizontal symmetry axis 250 and the example vertical symmetry axis 252 split the image frame 200 into four macroblocks: the example first macroblock 202, the example second macroblock 204, the example third macroblock 208, and the example fourth macroblock 206. The example vertical symmetry axis 252 and the example horizontal symmetry axis 250 meet and/or otherwise intersect at the convergence point 210. The example first directional guide line 248 is connected to the convergence point 210 and extends to the third corner 216.

The example first macroblock 202 includes the example first corner 212 and the example directional arrow 220. The example directional arrow 220 indicates the general direction a convergent sweep is carried out (e.g., wavefront propagation) by the example convergent sweep circuitry 106.

The example second macroblock 204 includes the example second directional arrow 222 that shows the direction that the example convergent sweep circuitry 106 processes waves of pixels. The example second macroblock includes the example first pixel 228, the example second pixel 230, the example third pixel 232, the example fourth pixel 234, the example fifth pixel 236, and the example sixth pixel 238. Each pixel is only a member of a single wave of pixels. For example, the first pixel 228 is included in a zeroth wave of pixels. The zeroth wave of pixels is an initial wave of pixels processed by the example convergent sweep circuitry 106 when performing a convergent sweep. Each of the four macroblocks has a zeroth wave (e.g., pixels labeled “0” in FIG. 2).

After the zeroth wave is processed, the example convergent sweep circuitry 106 processes the second pixel 230 and the third pixel 232, which form a first wave of pixels. In some examples, the second pixel 230 and the third pixel 230 are processed by SIMD processor circuitry for parallelization. The example pixels 234-238 are part of an example second wave of pixels. The example second wave of pixels is processed after the example first wave of pixels.

The example third macroblock 208 includes the example third corner 216 that is connected to the example convergence point 210 by the example directional guide line 248. The example first wave of pixels 240 includes rows of pixels (e.g., first convergent wave 240) that neighbor a previously processed wave and share a row or column with the previously processed wave. In the example third macroblock 208, the example convergent sweep circuitry 106 processes waves of pixels starting at the example third corner 216 (e.g., example zeroth wave) and continuing towards the convergence point 210 and along the example directional guide line 248, until all pixels of the example macroblock 208 are processed. For example, the eighth wave 244 would be processed seven waves after the example first wave 240.

The example frame 200 includes the example eighth convergent wave of the example fourth macroblock 206. The example fourth macroblock 206 includes the example fourth corner and the example fourth directional arrow 226 that generally indicates the direction the example convergent sweep circuitry 106 will process waves of pixels.

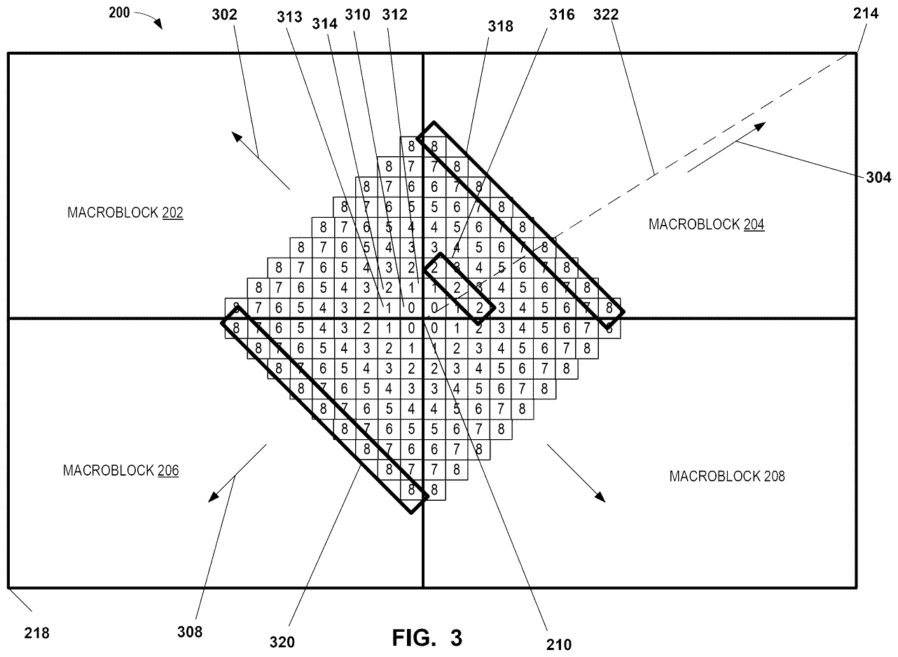

FIG. 3 is an illustration of the example image frame 200 in which the example divergent sweep circuitry 108 performs an example divergent sweep. In the illustrated example of FIG. 3, the image frame 200 includes an example fourth directional arrow 302, an example fifth directional arrow 304, an example sixth directional arrow 308, and an example second directional guide line 322.

As FIG. 3 illustrates a divergent sweep, the example directional arrows 302-308 are directed towards each macroblocks respective corner (e.g., corner 214 for the example second macroblock 204). The example second directional guide line 322 is a directional guide line for the example second macroblock 204. The example second macroblock 204 includes an example second divergent wave 316 and an example eighth divergent wave 318. Within each macroblock, the example divergent sweep circuitry 108 operates on sequential waves. For example, the second divergent wave 316 would be processed six waves before the example eighth divergent wave 318.

The example first macroblock 202 includes a second plurality of pixels 310-314. The example seventh pixel 310 is the pixel from a zeroth divergent wave, as the example seventh pixel 310 is nearest the convergence point 210. The example eighth pixel 312 and the example ninth pixel 313 are included in an example first divergent wave. The example tenth pixel 314 is a pixel of an example second divergent wave.

In operation, the example divergent sweep circuitry 108 first processes the example zeroth wave. After an example zeroth wave is processed, the example divergent sweep circuitry 108 processes a next wave that is nearer a respective opposite corner (e.g., opposite the convergence point) associated with the relevant macroblock. For example, the example divergent sweep circuitry 108 may next process the example first wave of each macroblock (e.g., all pixels marked “1” in FIG. 3). In some examples, each wave of a macroblock is processed by providing all pixels of a wave to a single instruction multiple data (SIMD) compute unit to increase parallelism. In some examples, the example divergent compute circuitry 108 executes waves of separate macroblocks at substantially the same time. For example, the example eighth divergent wave 318 of the example second macroblock 204 may be processed at substantially the same time as the example eighth divergent wave 320 of the example fourth macroblock 206.

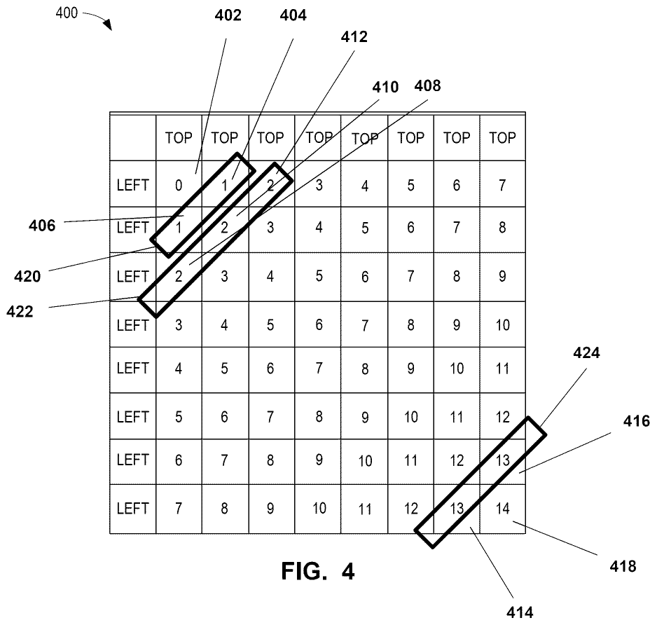

FIG. 4 is an illustration of an example fifth macroblock 400. The example fifth macroblock 400 includes an eleventh pixel 402, a twelfth pixel 404, a thirteenth pixel 406, a fourteenth pixel 408, a fifteenth pixel 410, a sixteenth pixel 412, a seventeenth pixel 414, an eighteenth pixel 416, a nineteenth pixel 418, an example first convergent wave 420, an example second convergent wave 422, and an example third convergent wave 424.

In operation, the example convergent sweep circuitry 106 performs a convergent sweep, starting at the example eleventh pixel 402 (e.g., of an example zeroth convergent wave). After the example eleventh pixel 402 is processed, the example convergent sweep circuitry 106 moves a wavefront to the example first wave of pixels 420 that includes the example twelfth pixel 404 and the example thirteenth pixel 406. The example convergent sweep circuitry 106 continues performing distance transform operations on pixels in waves until reaching the example thirteenth wave of pixels 424 that includes the example eighteenth pixel 414 and the example nineteenth pixel 416. The example convergent sweep circuitry 106 would complete operations at the example nineteenth pixel 418. Thus, the example convergent sweep circuitry 106 begins processing waves of pixels at a top left corner (e.g., eleventh pixel 402) and processes diagonal waves towards a bottom right corner (e.g., the example nineteenth pixel 418).

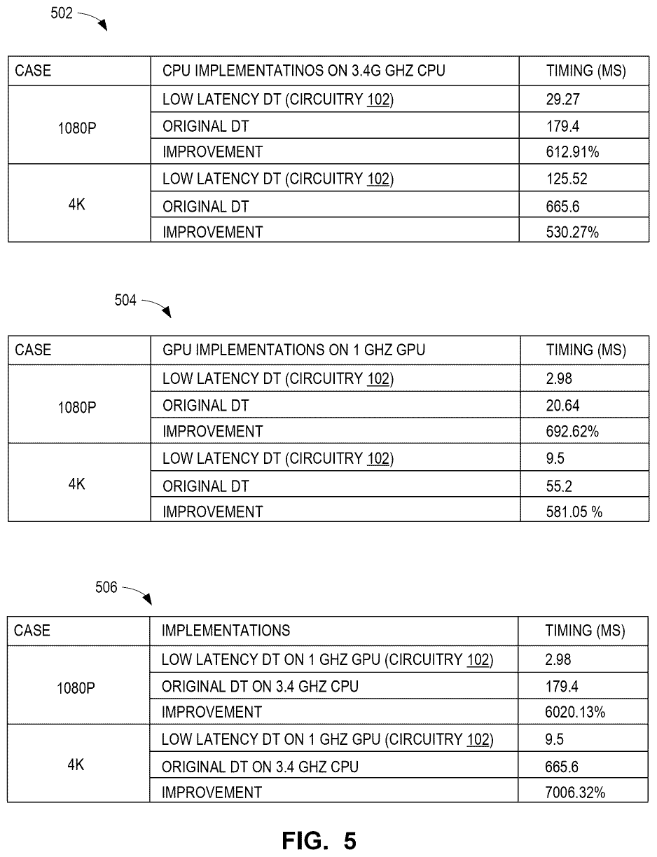

FIG. 5 provides example data illustrating improvements to computer hardware associated with the example image processing circuitry 102 of FIG. 1. FIG. 5 includes an example first table 502, an example second table 504, and an example third table 506. The example first table 502 illustrates improvements provided by the example image processing circuitry 102. The example first table 502 illustrates example techniques described herein implemented on a 3.4 gigahertz (GHz) CPU. The example table 502 shows that, for example, on a 1080p image, an improved distance transform carried out by the example image processing circuitry 102 executes in 29.27 milliseconds (ms). This is a 612.91% improvement over a conventional distance transform that executes in 179.4 ms.

The example second table 504 illustrates additional performance improvements provided by the example image processing circuitry 102 when performing a distance transform on a 1 GHz GPU. On a 1080p image, the example image processing circuitry 102 executes a distance transform in only 2.98 ms, compared to 20.64 ms for conventional distance transform techniques. Therefore, in this example, the image processing circuitry 102 provides a 692.62% improvement over conventional hardware/software techniques.

The example third table 506 illustrates further performance improvements provided by the example image processing circuitry 102. The example third table 506 shows that disclosed techniques can perform a distance transform on a 4K image in 9.5 ms when executed on a 1 GHz GPU. This is compared to conventional solutions that execute a distance transform in 665.6 ms, a 7006.32% performance improvement.

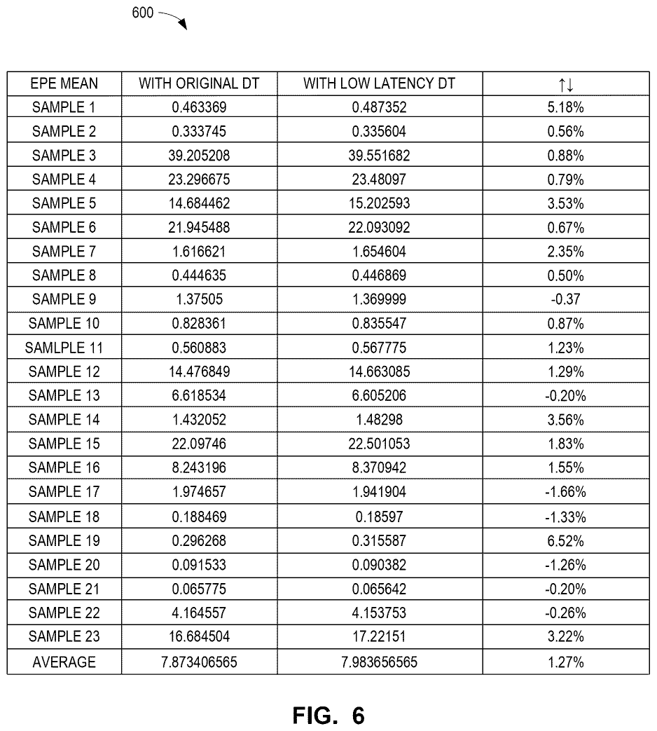

FIG. 6 is an example table 600 comparing endpoint error (EPE) rates associated with conventional techniques to EPE rates associated with the example image transform circuitry 102. EPE is a mean value of absolute error among all pixels in an image. Thus, the example fourth table 600 illustrates that, on average, the mean EPE for conventional techniques is 7.67, while the mean for the example image processing circuitry 102 (e.g., performing a low-latency distance transform) is 7.983. This is an increase of only 1.27%. Thus, when FIG. 5 and FIG. 6 are analyzed together, the example image transform circuitry 102 in some examples provides a greater than 7000% performance improvement with only a 1.27% increase in EPE (e.g., on average).

Flowcharts representative of example hardware logic circuitry, machine readable instructions, hardware implemented state machines, and/or any combination thereof for implementing the image processing circuitry 102 of FIG. 1 is shown in FIGS. 7-9. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 7-9, many other methods of implementing the example image processing circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 7 is a flowchart representative of example machine readable instructions and/or example operations 700 that may be executed and/or instantiated by processor circuitry to generate a distance map. The machine readable instructions and/or the operations 700 of FIG. 7 begin at block 702, at which the example macroblock generator circuitry 104 of FIG. 1 assigns macroblocks to compute units. For example, the macroblock generator circuitry 104 of FIG. 1 may divide a frame into four quadrants and assign each quadrant to a SIMD compute unit.

At block 704, the example convergent sweep circuitry 106 performs a convergent sweep. For example, the convergent sweep circuitry 106 of FIG. 1 may perform a convergent sweep to process pixels of the assigned macroblocks starting at corners opposite the convergence point and processing diagonal waves of pixels. The operations of block 704 will be described in further detail in association with FIG. 8.

At block 706, the example divergent sweep circuitry 108 of FIG. 1 performs a divergent sweep. For example, the divergent sweep circuitry 108 of FIG. 1 may perform a divergent sweep of the plurality of macroblocks with the plurality of compute units. The example divergent sweep circuitry 108 of FIG. 1 may operate on sets of pixels starting at the convergence point and finishing at corners opposite the convergence point. The example operations of block 706 will be described in further detail in association with FIG. 9.

At block 708, the example distance transform circuitry 110 of FIG. 1 generates a distance map. For example, the distance transform circuitry 110 of FIG. 1 may generate a distance map based on distance calculations performed during the convergent and divergent sweeps. In some examples, the example distance transform circuitry 110 of FIG. 1 may iteratively generate a distance map during convergent and divergent sweeps. The instructions 700 end.

FIG. 8 is a flowchart representative of example machine readable instructions and/or example operations 704 that may be executed and/or instantiated by processor circuitry to perform a convergent sweep. The machine readable instructions and/or the operations 704 of FIG. 7 begin at block 802, at which the example convergent sweep circuitry 106 of FIG. 1 processes a set of pixels at a corner opposite the convergence point. For example, a plurality of SIMD compute units may operate on zeroth waves of pixels located at corners opposite a convergence point of an example frame. In some examples, all pixels of the zeroth wave are processed before continuing to a first wave, all pixels of the first wave are processed before continuing to a second wave, etc.

At block 804, the example convergent sweep circuitry 106 of FIG. 1 identifies a set of pixels nearer a convergence point and substantially orthogonal (e.g., directly orthogonal in the event of a square macroblock, with slight deviations to direct orthogonality when the macroblock shape exhibits different rectangular configurations) to a directional guide line. For example, the convergent sweep circuitry may identify a set of pixels that neighbor the most recently processed set of pixels, but are nearer to the convergence point along a line extending from a frame corner to the convergence point.

At block 806, the example convergent sweep circuitry 106 of FIG. 1 and/or the example distance transform circuitry 110 of FIG. 1 processes pixels in the identified set. For example, the example distance transform circuitry 110 of FIG. 1 may generate a distance map based on the convergent sweep and based on the divergent sweep, the convergent sweep to generate shortest paths from pixels of the plurality of pixels to first seeds that are along the horizontal and/or vertical symmetry axes.

At block 808, the example distance transform circuitry 110 of FIG. 1 updates the distance map with a distance to seeds along vertical and horizontal symmetry axes. For example, the distance transform circuitry 110 of FIG. 1 may update a distance map as the example convergent sweep circuitry 106 of FIG. 1 identifies waves of pixels for processing. In some examples, the image processing circuitry 102 of FIG. 1 may perform alternative operations instead of distance transform operations. For example, the convergent sweep circuitry 106 of FIG. 1 may perform a graphical search instead of a distance transform.

At block 810, the example image processing circuitry 102 of FIG. 1 determines if convergence of waves of each macroblock has occurred. For example, four GPU threads may be operating on waves of four different macroblocks. During the divergent phase, a final wave of pixels of each macroblock may be the wave nearest (e.g., adjacent to or on) a convergence point (e.g., a center point) of a frame. If the GPU threads have converged (e.g., processed all pixels of the frame) then the example instructions continue at block 706. Otherwise, the instructions return to block 804 in which a next set of pixels are identified for processing.

FIG. 9 is a flowchart representative of example machine readable instructions and/or example operations 706 that may be executed and/or instantiated by processor circuitry to perform a divergent sweep. The machine readable instructions and/or the operations 706 of FIG. 7 begin at block 902, at which the example divergent sweep circuitry 108 of FIG. 1 processes a set of pixels at the convergence point. For example, a plurality of SIMD compute units may operate on zeroth waves of pixels located at the convergence point of a sample frame. In some examples, all pixels of a current wave are processed before continuing to subsequent waves.

At block 904, the example divergent sweep circuitry 108 of FIG. 1 identifies a set of pixels nearer an outer corner and substantially orthogonal (e.g., directly orthogonal in the event of a square macroblock, with slight deviations to direct orthogonality when the macroblock shape exhibits different rectangular configurations) to a directional guide line. For example, the divergent sweep circuitry 108 of FIG. 1 may identify a set of pixels that neighbor the most recently processed set of pixels, but are nearer to a respective corner point along a line extending from the convergence point.

At block 906, the example divergent sweep circuitry 108 of FIG. 1 and/or the example distance transform circuitry 110 of FIG. 1 process pixels in the identified set. For example, the example distance transform circuitry 110 of FIG. 1 may generate a distance map based on the divergent sweep, the convergent sweep to generate shortest paths from pixels of the plurality of pixels to second seeds that are farther from the horizontal and/or vertical symmetry axes than first seeds.

At block 908, the example distance transform circuitry 110 of FIG. 1 updates a distance map with the distance to seeds farther from the vertical and horizontal symmetry axes. For example, the distance transform circuitry 110 of FIG. 1 may update a distance map as the example divergent sweep circuitry 108 of FIG. 1 identifies waves of pixels for processing. In some examples, the image processing circuitry 102 may perform alternative operations instead of distance transform operations. For example, the divergent sweep circuitry 108 of FIG. 1 may perform a graphical search instead of a distance transform.

At block 910, the example image processing circuitry 102 of FIG. 1 determines if divergent of waves of each macroblock have reached respective corners. For example, four GPU threads may be operating on waves in four different macroblocks. During the divergent phase, a final wave of pixels of each macroblock may be adjacent to or on a corner of a frame. If the GPU threads have processed all pixels of the frame, then the example instructions continue at block 708. Otherwise the instructions return to block 904 in which a next set of pixels are identified for processing.

FIG. 10 is a block diagram of an example processor platform 1000 structured to execute and/or instantiate the machine readable instructions and/or the operations of FIGS. 7-9 to implement the image processing circuitry 102 of FIG. 1. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example macroblock generator circuitry 104, the example convergent sweep circuitry 106, the example divergent sweep circuitry 108, the example distance transform circuitry 110, and the example communication circuitry 112.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIGS. 7-9, may be stored in the mass storage device 1028, in the volatile memory 1014, in the non-volatile memory 1016, and/or on a removable non-transitory computer readable storage medium such as a CD or DVD.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowchart of FIGS. 7-9 to effectively instantiate the circuitry of FIG. 1 as logic circuits to perform the operations corresponding to those machine readable instructions. In some such examples, the circuitry of FIG. 1 is instantiated by the hardware circuits of the microprocessor 1100 in combination with the instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowchart of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1(L 1 ) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 12 is a block diagram of another example implementation of the processor circuitry 1012 of FIG. 10. In this example, the processor circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowchart of FIGS. 7-9 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowchart of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIGS. 7-9. As such, the FPGA circuitry 1200 may be structured to effectively instantiate some or all of the machine readable instructions of the flowchart of FIGS. 7-9 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 7-9 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may be implemented by external hardware circuitry. For example, the external hardware 1206 may be implemented by the microprocessor 1200 of FIG. 12. The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations that may correspond to at least some of the machine readable instructions of FIGS. 7-9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

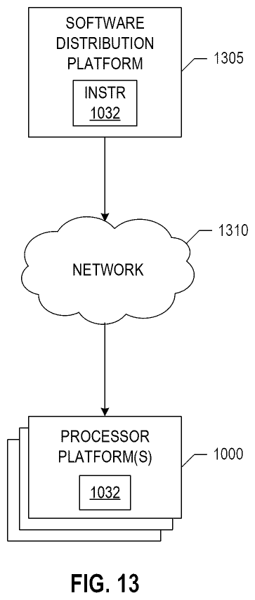

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1300 of FIG. 13. In some such hybrid examples, a first portion of the machine readable instructions represented by the flowchart of FIGS. 7-9 may be executed by one or more of the cores 1102 of FIG. 11, a second portion of the machine readable instructions represented by the flowcharts of FIG. 7-9 may be executed by the FPGA circuitry 1300 of FIG. 13, and/or a third portion of the machine readable instructions represented by the flowcharts of FIGS. 7-9 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 1012 of FIG. 4 may be in one or more packages. For example, the microprocessor 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

A block diagram illustrating an example software distribution platform 1305 to distribute software such as the example machine readable instructions 1032 of FIG. 10 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions 700 of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions 700 of FIGS. 7-9, may be downloaded to the example processor platform 1000, which is to execute the machine readable instructions 1032 to implement the image processing circuitry 102 of FIG. 1. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

From the foregoing, it will be appreciated that example systems, methods, apparatus, and articles of manufacture have been disclosed that process image frames. Disclosed systems, methods, apparatus, and articles of manufacture improve the efficiency of using a computing device by performing a low latency distance transform on frames in two sweeps: a divergent sweep and a convergent sweep. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to perform video analytics are disclosed herein. Further examples and combinations thereof include the following:

Example 1 includes an apparatus comprising at least one memory, machine readable instructions, and processor circuitry to execute the machine readable instructions to generate macroblocks from an image frame, the macroblocks to meet at a convergence point, assign compute units to the macroblocks to process pixels of the macroblocks in parallel, perform a convergent sweep of the macroblocks with the compute units, the convergent sweep to process pixels of the macroblocks starting at corners opposite the convergence point and ending at the convergence point, and perform a divergent sweep of the macroblocks with the compute units, the divergent sweep to process the pixels of the macroblocks starting from the convergence point and ending at the corners opposite the convergence point.

Example 2 includes the apparatus of any of the previous examples, wherein the processor circuitry is to execute the machine readable instructions to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

Example 3 includes the apparatus of any of the previous examples, wherein to perform the convergent sweep, the processor circuitry is to execute the machine readable instructions to process the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

Example 4 includes the apparatus of any of the previous examples, wherein to perform the divergent sweep, the processor circuitry is to execute the machine readable instructions to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

Example 5 includes the apparatus of any of the previous examples, wherein to perform the convergent sweep, the processor circuitry is to execute the machine readable instructions to process a first segment of the pixels that form a first line orthogonal to a second line that extends from the convergence point to a corner opposite the convergence point, and process a second segment of the pixels that neighbors the first segment of the pixels and is closer to the convergence point.

Example 6 includes the apparatus of any of the previous examples, wherein to perform the divergent sweep, the processor circuitry is to execute the machine readable instructions to process a first segment of the pixels that form a straight line, and process a second segment of pixels that neighbors the first segment of the pixels.

Example 7 includes the apparatus of any of the previous examples, wherein the processor circuitry is to execute the machine readable instructions to perform a low-latency distance transform with the convergent sweep followed by the divergent sweep, wherein the compute units are single instruction multiple data (SIMD) compute units, the macroblocks include four macroblocks with an equivalent number of pixels, and wherein SIMD compute units process the pixels in parallel with SIMD compute instructions.

Example 8 includes a computer readable medium comprising instructions which, when executed, cause processor circuitry to generate macroblocks from an image frame, the macroblocks to meet at a convergence point, assign compute units to the macroblocks to process pixels of the macroblocks in parallel, perform a convergent sweep of the macroblocks with the compute units, the convergent sweep to process pixels of the macroblocks starting at corners opposite the convergence point and ending at the convergence point, and perform a divergent sweep of the macroblocks with the compute units, the divergent sweep to process the pixels of the macroblocks starting from the convergence point and ending at the corners opposite the convergence point.

Example 9 includes the computer readable medium of any of the previous examples, wherein the instructions, when executed, cause the processor circuitry to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

Example 10 includes the computer readable medium of any of the previous examples, wherein the instructions, when executed to perform the convergent sweep, cause the processor circuitry to process the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

Example 11 includes the computer readable medium of any of the previous examples, wherein the instructions, when executed to perform the divergent sweep, cause the processor circuitry to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

Example 12 includes the computer readable medium of any of the previous examples, wherein the instructions, when executed to perform the convergent sweep, cause the processor circuitry to process a first segment of the pixels that form a first line orthogonal to a second line that extends from the convergence point to a corner opposite the convergence point, and process a second segment of the pixels that neighbors the first segment of the pixels and is closer to the convergence point.

Example 13 includes the computer readable medium of any of the previous examples, wherein the instructions, when executed to perform the divergent sweep, cause the processor circuitry to process a first segment of the pixels that form a straight line, and process a second segment of pixels that neighbors the first segment of the pixels.

Example 14 includes the computer readable medium of any of the previous examples, wherein the instructions, when executed, cause the processor circuitry to perform a low-latency distance transform with the convergent sweep followed by the divergent sweep, wherein the compute units are single instruction multiple data (SIMD) compute units, the macroblocks include four macroblocks with an equivalent number of pixels, and wherein SIMD compute units process the pixels in parallel with SIMD compute instructions.

Example 15 includes a method comprising generating, by executing an instruction with processor circuitry, macroblocks from an image frame, the macroblocks to meet at a convergence point, assigning, by executing an instruction with the processor circuitry, compute units to the macroblocks to process pixels of the macroblocks in parallel, performing, by executing an instruction with the processor circuitry, a convergent sweep of the macroblocks with the compute units, the convergent sweep to process pixels of the macroblocks starting at corners opposite the convergence point and ending at the convergence point, and performing, by executing an instruction with the processor circuitry a divergent sweep of the macroblocks with the compute units, the divergent sweep to process the pixels of the macroblocks starting from the convergence point and ending at the corners opposite the convergence point.

Example 16 includes the method of any of the previous examples, further including executing the machine readable instructions to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

Example 17 includes the method of any of the previous examples, further including processing the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

Example 18 includes the method of any of the previous examples, further including executing the machine readable instructions to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

Example 19 includes the method of any of the previous examples, further including processing a first segment of the pixels that form a first line orthogonal to a second line that extends from the convergence point to a corner opposite the convergence point, and processing a second segment of the pixels that neighbors the first segment of the pixels and is closer to the convergence point.

Example 20 includes the method of any of the previous examples, further including processing a first segment of the pixels that form a straight line, and processing a second segment of pixels that neighbors the first segment of the pixels.

Example 21 includes the method of any of the previous examples, further including performing a low-latency distance transform with the convergent sweep followed by the divergent sweep, wherein the compute units are single instruction multiple data (SIMD) compute units, the macroblocks include four macroblocks with an equivalent number of pixels, and wherein SIMD compute units process the pixels in parallel with SIMD compute instructions.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to execute the machine readable instructions to:
generate macroblocks from an image frame, the macroblocks to meet at a convergence point;
assign compute units to the macroblocks to process pixels of the macroblocks in parallel;
perform a convergent sweep of the macroblocks with the compute units, the convergent sweep to process pixels of the macroblocks starting at corners opposite the convergence point and ending at the convergence point; and
perform a divergent sweep of the macroblocks with the compute units, the divergent sweep to process the pixels of the macroblocks starting at the convergence point and ending at the corners opposite the convergence point.

2. The apparatus of claim 1, wherein the processor circuitry is to execute the machine readable instructions to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

3. The apparatus of claim 1, wherein to perform the convergent sweep, the processor circuitry is to execute the machine readable instructions to process the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

4. The apparatus of claim 1, wherein to perform the divergent sweep, the processor circuitry is to execute the machine readable instructions to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

5. The apparatus of claim 1, wherein to perform the convergent sweep, the processor circuitry is to execute the machine readable instructions to:
process a first segment of the pixels that form a first line orthogonal to a second line that extends from the convergence point to a corner opposite the convergence point; and
process a second segment of the pixels that neighbors the first segment of the pixels and is closer to the convergence point.

6. The apparatus of claim 1, wherein to perform the divergent sweep, the processor circuitry is to execute the machine readable instructions to process a first segment of the pixels that form a straight line; and
process a second segment of pixels that neighbors the first segment of the pixels.

7. The apparatus of claim 1, wherein the processor circuitry is to execute the machine readable instructions to perform a low-latency distance transform with the convergent sweep followed by the divergent sweep, wherein the compute units are single instruction multiple data (SIMD) compute units, the macroblocks include four macroblocks with an equivalent number of pixels, and wherein SIMD compute units process the pixels in parallel with SIMD compute instructions.

8. A non-transitory computer readable medium comprising instructions which, when executed, cause processor circuitry to:
generate macroblocks from an image frame, the macroblocks to meet at a convergence point;
assign compute units to the macroblocks to process pixels of the macroblocks in parallel;
perform a convergent sweep of the macroblocks with the compute units, the convergent sweep to process pixels of the macroblocks starting at corners opposite the convergence point and ending at the convergence point; and
perform a divergent sweep of the macroblocks with the compute units, the divergent sweep to process the pixels of the macroblocks starting from the convergence point and ending at the corners opposite the convergence point.

9. The non-transitory computer readable medium of claim 8, wherein the instructions, when executed, cause the processor circuitry to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

10. The non-transitory computer readable medium of claim 8, wherein the instructions, when executed to perform the convergent sweep, cause the processor circuitry to process the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

11. The non-transitory computer readable medium of claim 8, wherein the instructions, when executed to perform the divergent sweep, cause the processor circuitry to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

12. The non-transitory computer readable medium of claim 8, wherein the instructions, when executed to perform the convergent sweep, cause the processor circuitry to:
process a first segment of the pixels that form a first line orthogonal to a second line that extends from the convergence point to a corner opposite the convergence point; and
process a second segment of the pixels that neighbors the first segment of the pixels and is closer to the convergence point.

13. The non-transitory computer readable medium of claim 8, wherein the instructions, when executed to perform the divergent sweep, cause the processor circuitry to process a first segment of the pixels that form a straight line; and
process a second segment of pixels that neighbors the first segment of the pixels.

14. The non-transitory computer readable medium of claim 8, wherein the instructions, when executed, cause the processor circuitry to perform a low-latency distance transform with the convergent sweep followed by the divergent sweep, wherein the compute units are single instruction multiple data (SIMD) compute units, the macroblocks include four macroblocks with an equivalent number of pixels, and wherein SIMD compute units process the pixels in parallel with SIMD compute instructions.

15. A method comprising:
generating, by executing an instruction with processor circuitry, macroblocks from an image frame, the macroblocks to meet at a convergence point;
assigning, by executing an instruction with the processor circuitry, compute units to the macroblocks to process pixels of the macroblocks in parallel;
performing, by executing an instruction with the processor circuitry, a convergent sweep of the macroblocks with the compute units, the convergent sweep to process pixels of the macroblocks starting at corners opposite the convergence point and ending at the convergence point; and
performing, by executing an instruction with the processor circuitry a divergent sweep of the macroblocks with the compute units, the divergent sweep to process the pixels of the macroblocks starting from the convergence point and ending at the corners opposite the convergence point.

16. The method of claim 15, further including executing the machine readable instructions to generate a distance map based on the convergent sweep and based on the divergent sweep, the convergent sweep to generate shortest paths from the pixels of the macroblocks to first seeds, the divergent sweep to generate shortest paths from the pixels of the macroblocks to second seeds, the second seeds farther away from vertical and horizontal symmetry axes of the image frame than the first seeds.

17. The method of claim 15, further including processing the pixels in waves of pixels, a first wave of the waves of pixels processed before a second wave of the waves of pixels, the second wave including second pixels that neighbor the first wave and share a row or column with the first wave, and wherein final waves of the waves of pixels converge at the convergence point.

18. The method of claim 15, further including executing the machine readable instructions to process the pixels in second waves of pixels, a first wave of the second waves of pixels to be processed before a second wave of the second waves of pixels, the second wave of the second waves of pixels including second pixels that neighbor the first wave, share a row or column with the first wave, and have not been processed in the divergent sweep.

19. The method of claim 15, further including:
processing a first segment of the pixels that form a first line orthogonal to a second line that extends from the convergence point to a corner opposite the convergence point; and
processing a second segment of the pixels that neighbors the first segment of the pixels and is closer to the convergence point.

20. The method of claim 15, further including processing a first segment of the pixels that form a straight line; and
processing a second segment of pixels that neighbors the first segment of the pixels.

21. (canceled)
